(19) United States
(12) Patent Application Publication
(10) Pub. No.: US 2018/0157074 A1
(43) Pub. Date: Jun. 7, 2018

(54) LIQUID CRYSTAL DISPLAY DEVICE IN PERPENDICULAR ALIGNMENT AND METHOD OF DRIVING THE SAME

(71) Applicant: Shenzhen China Star Optoelectronics Technology Co. Ltd., Shenzhen (CN)

(72) Inventors: Bai BAI, Shenzhen (CN); Xinhui ZHONG, Shenzhen (CN)

(73) Assignee: Shenzhen China Star Optoelectronics Technology Co. Ltd., Shenzhen (CN)

(21) Appl. No.: 14/897,695

(22) PCT Filed: Aug. 28, 2015
(86) PCT No.: PCT/CN2015/088402

§ 371 Date: Jan. 31, 2018

(30) Foreign Application Priority Data
Aug. 14, 2015 (CN) 201510498384.9

(51) Int. Cl. G02F 1/1343; G09G 3/36; G02F 1/1335

(52) U.S. Cl. CPC G02F 1/1343; G02F 1/133528; G09G 3/36

(57) ABSTRACT

A liquid crystal display device in vertical alignment and a method for driving the same are disclosed. In the liquid crystal display device, a first horizontal electrode and a second horizontal electrode are added on the basis of a traditional structure. A horizontal electric field can be formed between the first horizontal electrode and the second horizontal electrode, so that negative liquid crystal molecules can rotate along a horizontal direction to a direction of a light transmission axis of a polarizer. A process in which the liquid crystal display device is converted into a dark state from a bright state can be accelerated, and declining time can be effectively shortened. The liquid crystal display device has a high response speed, and a better display effect can be obtained when a dynamic image which moves at a high speed is displayed.

### CROSS REFERENCE TO RELATED APPLICATIONS

The present application claims the priority of Chinese patent application CN201510498384.9, entitled “Liquid Crystal Display Device in Perpendicular Alignment and Method of Driving the Same” and filed on Aug. 14, 2015, the entirety of which is incorporated herein by reference.

### FIELD OF THE INVENTION

The present disclosure relates to the technical field of display, and particularly to a liquid crystal display device in vertical alignment and a method for driving the liquid crystal display device.

### BACKGROUND OF THE INVENTION

In recent years, active Thin Film Transistor Liquid Crystal Display (TFT-LCD) has been rapidly developed and widely used. There are many parameters for evaluating the performance of a TFT-LCD, such as resolution, picture contrast, color gamut, response time, and so on. The response time represents a time period a brightness switching process of the liquid crystal panel accounts, which is an important parameter reflecting a dynamic response ability of liquid crystal. In general, the shorter the response time is, the higher the highest image refresh rate of the display panel can be realized. In this manner, the smaller the smear degree is, and the clearer the dynamic image which moves at a high speed displayed therein can become.

The response time comprises a rising time and a declining time. FIG. 1 schematically shows changing of brightness (or light transmittance) of a display panel with time. As shown in FIG. 1, the rising time refers to a time period during which the brightness (or the light transmittance) of the display panel rises from 10% to 90%, and the declining time refers to a time period during which the brightness (or the light transmittance) of the display panel declines from 90% to 10%.

According to a calculation formula of the rising time, it can be seen that, the rising time is strongly dependent on an operating voltage. The higher the operating voltage is, the shorter the rising time would become. According to a calculation formula of the declining time, it can be seen that, the declining time is only dependent on design of a liquid crystal cell and the characteristics of a liquid crystal material, for example, a dielectric constant of the liquid crystal material. Therefore, during practical application, the rising time can be shortened through improving the operating voltage, while the declining time can be shortened through changing the design of the liquid crystal cell or changing the liquid crystal material therein.

Compared with the method for shortening the rising time, the method for shortening the declining time is more complicated, and has a low feasibility. On the one hand, if the declining time is shortened through changing the liquid crystal material in the display panel, other performances of the display panel would possibly be affected. For example, the temperature range in which the display panel can be used would be narrowed. On the other hand, it is difficult to shorten the declining time through improving the design of the liquid crystal cell.

### SUMMARY OF THE INVENTION

The present disclosure provides a liquid crystal display device in Vertical Alignment (VA) in which the declining time can be shortened. The present disclosure further provides a method for driving the liquid crystal display device. According to the present disclosure, a high speed response of the liquid crystal display device can be realized.

According to a first aspect, the present disclosure provides a liquid crystal display device in vertical alignment, which comprises:

a first substrate and a second substrate that are arranged facing each other, and a negative liquid crystal layer that is arranged between the first substrate and the second substrate;

a first polarizer and a second polarizer that are formed on an outer surface of the first substrate and an outer surface of the second substrate respectively, a light transmission axis of the first polarizer being perpendicular to a light transmission axis of the second polarizer;

a first vertical electrode and a first vertical alignment layer that are formed on an inner surface of the first substrate in sequence; and

a second vertical electrode, an insulation layer, a first horizontal electrode, a second horizontal electrode, and a second vertical alignment layer that are formed on an inner surface of the second substrate in sequence, wherein the first horizontal electrode and the second horizontal electrode are arranged parallel to each other in a same layer and parallel to the light transmission axis of the first polarizer or the second polarizer.

Preferably, the first vertical electrode and the second vertical electrode both are planar electrodes.

Preferably, the first horizontal electrode and/or the second horizontal electrode is a comb electrode.

Preferably, the light transmission axis of the first polarizer extends along a 0° direction, and the light transmission axis of the second polarizer extends along a 90° direction; or the light transmission axis of the first polarizer extends along a 90° direction, and the light transmission axis of the second polarizer extends along a 0° direction.

Preferably, the liquid crystal display device further comprises a driving circuit, which comprises a horizontal driving module, wherein the horizontal driving module is configured to control conversion of the liquid crystal display device into a dark state from a bright state,

wherein the horizontal driving module is configured to stop supplying power to the first vertical electrode and the second vertical electrode, start to supply power to the first horizontal electrode and the second horizontal electrode at the same time, and enable a voltage difference between the first horizontal electrode and the second horizontal electrode to reach a first preset voltage difference; and

wherein the horizontal driving module is configured to stop supplying power to the first horizontal electrode and the second horizontal electrode when a time period during which power is supplied to the first horizontal electrode and the second horizontal electrode reaches a preset time period.

Preferably, the first preset voltage difference ranges from 2 V to 10 V, and/or the preset time period ranges from 1 ms to 10 ms.

Preferably, the driving circuit further comprises a vertical driving module, which is configured to control conversion of the liquid crystal display device into a bright state from a dark state, and the vertical driving module is specifically configured to supply power to the first vertical electrode and the second vertical electrode, and enable a voltage difference between the first vertical electrode and the second vertical electrode to reach a second preset voltage difference.

According to a second aspect, the present disclosure provides a method for driving the aforesaid liquid crystal display device in vertical alignment, and the method comprises controlling conversion of the liquid crystal display device into a dark state from a bright state. The method comprises:

stopping power supply to the first vertical electrode and the second vertical electrode, at the same time, supplying power to the first horizontal electrode and the second horizontal electrode, and enabling a voltage difference between the first horizontal electrode and the second horizontal electrode to reach a first preset voltage difference;

determining whether a time period during which power is supplied to the first horizontal electrode and the second horizontal electrode reaches a preset time period; and

if yes, stopping power supply to the first horizontal electrode and the second horizontal electrode.

Preferably, the first preset voltage difference ranges from 2 V to 10 V, and/or the preset time period ranges from 1 ms to 10 ms.

Preferably, the method further comprises controlling conversion of the liquid crystal display device into a bright state from a dark state, which comprises supplying power to the first vertical electrode and the second vertical electrode, and enabling a voltage difference between the first vertical electrode and the second vertical electrode to reach a second preset voltage difference.

Compared with the prior art, one embodiment or a plurality of embodiments according to the present disclosure may have the following advantages or beneficial effects.

In the liquid crystal display device in vertical alignment according to the present disclosure, the first horizontal electrode and the second horizontal electrode are added on the basis of the traditional structure. A horizontal electric field can be formed between the first horizontal electrode and the second horizontal electrode, so that the negative liquid crystal molecules can rotate along horizontal direction to a direction of the light transmission axis of the polarizer. A process in which the liquid crystal display device is converted into the dark state from the bright state can be accelerated, and declining time can be effectively shortened. According to the present disclosure, the liquid crystal display device has a high response speed, and a better display effect can be obtained when a dynamic image which moves at a high speed is displayed.

According to the present disclosure, the rotation of the liquid crystal molecules can be accelerated by the horizontal electric field, while the structure of the liquid crystal cell and the liquid crystal material do not change. Therefore, the declining time can be shortened effectively, while other good performances of the liquid crystal display device would not be affected. The method disclosed herein has a good feasibility.

Other features and advantages of the present disclosure will be further explained in the following description, and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

The accompanying drawings provide further understandings of the present disclosure and constitute one part of the description. The drawings are used for interpreting the present disclosure together with the embodiments, not for limiting the present disclosure. In the drawings:

FIG. 1 schematically shows changing of brightness of a liquid crystal display panel with time;

FIG. 2a schematically shows a liquid crystal display device in vertical alignment in a dark state when no power is supplied according to one embodiment of the present disclosure;

FIG. 2b schematically shows projections of negative liquid crystal molecules as shown in FIG. 2a on an insulation layer;

FIG. 3a schematically shows the liquid crystal display device in vertical alignment in a bright state according to one embodiment of the present disclosure;

FIG. 3b schematically shows projections of negative liquid crystal molecules as shown in FIG. 3a on an insulation layer;

FIG. 4a schematically shows the liquid crystal display device in vertical alignment in a dark state under a horizontal electric field according to one embodiment of the present disclosure;

FIG. 4b schematically shows projections of negative liquid crystal molecules as shown in FIG. 4a on an insulation layer;

FIG. 5 schematically shows a state of a negative liquid crystal molecule when the liquid crystal display device is in a bright state; and

FIG. 6 is a flow chart of a method for controlling conversion of the liquid crystal display device into a dark state from a bright state.

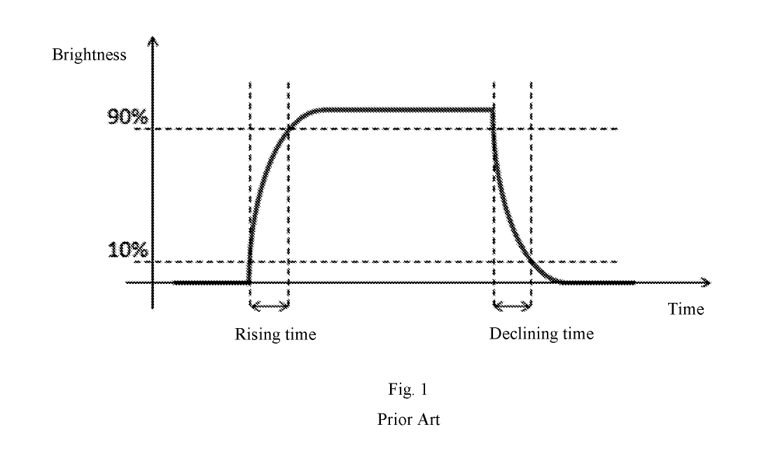

### DETAILED DESCRIPTION OF THE EMBODIMENTS

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It should be noted that, as long as there is no structural conflict, all the technical features mentioned in all the embodiments may be combined together in any manner, and the technical solutions obtained in this manner all fall within the scope of the present disclosure.

The embodiment of the present disclosure provides a liquid crystal display device in vertical alignment, whereby a declining time can be shortened, and a high speed response can be realized.

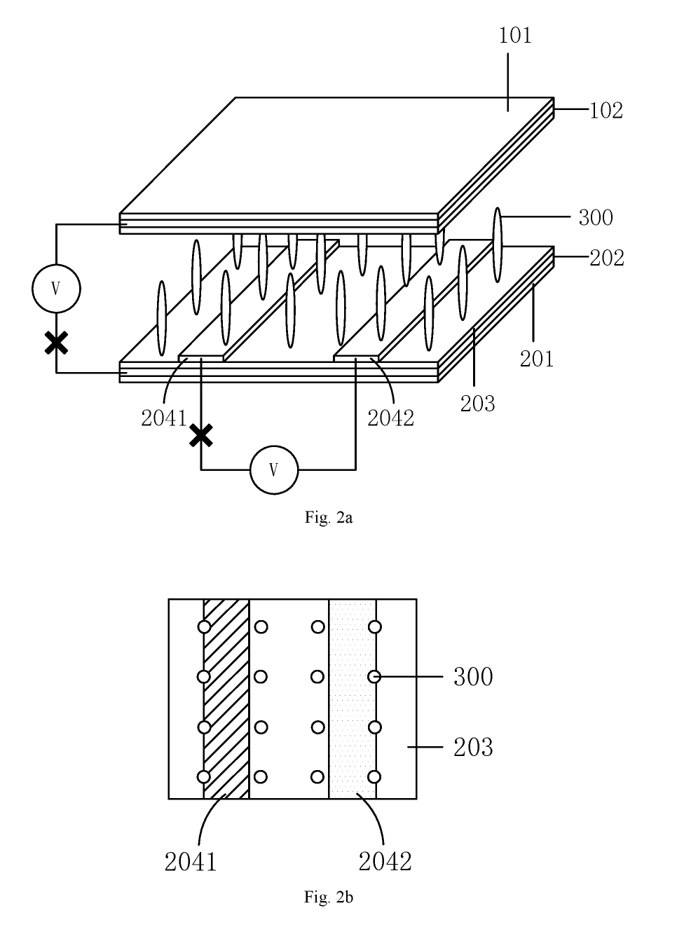

As shown in FIG. 2a, according to the embodiment of the present disclosure, the liquid crystal display device in vertical alignment mainly comprises a first substrate 101, a second substrate 201, a negative liquid crystal layer 300, a first polarizer, a first vertical electrode 102, a first vertical alignment layer, a second polarizer, a second vertical electrode 202, an insulation layer 203, a first horizontal electrode 2041, a second horizontal electrode 2042, and a second vertical alignment layer. The first polarizer, the second polarizer, the first vertical alignment layer, and the second vertical alignment layer are not shown in FIG. 2a. An inner side of the first substrate 101 and an inner side of the second substrate 201 are arranged facing each other, i.e., an inner surface of the first substrate 101 and an inner surface of the second substrate 201 are arranged facing each other. The negative liquid crystal layer 300 is arranged between the first substrate 101 and the second substrate 201. The first polarizer, the first vertical electrode 102, and the first vertical alignment layer are arranged on the first substrate 101. The second polarizer, the second vertical electrode 202, the insulation layer 203, the first horizontal electrode 2041, the second horizontal electrode 2042, and the second vertical alignment layer are arranged on the second substrate 201.

Specifically, the first polarizer is formed on an outer surface of the first substrate 101, and the second polarizer is formed on an outer surface of the second substrate 201. A light transmission axis of the first polarizer is perpendicular to a transmission axis of the second polarizer. The light transmission axis of the first polarizer extends along a 0° direction, and the light transmission axis of the second polarizer extends along a 90° direction. Or, the light transmission axis of the first polarizer extends along a 90° direction, and the light transmission axis of the second polarizer extends along a 0° direction.

The first vertical electrode 102 is preferably a planar electrode. The first vertical electrode 102 is formed on the inner surface of the first substrate 101, and the first vertical alignment layer covers an inner surface of the first vertical electrode 102.

The second vertical electrode 202 is preferably a planar electrode. The second vertical electrode 202 is formed on the inner surface of the second substrate 201, and the insulation layer 203 is formed on an inner surface of the second vertical electrode 202. The first horizontal electrode 2041 and the second horizontal electrode 2042 are arranged in a same layer on an inner surface of the insulation layer 203. The first horizontal electrode 2041 and the second horizontal electrode 2042 are preferably comb electrodes. Moreover, the first horizontal electrode 2041 and the second horizontal electrode 2042 are arranged parallel to each other and parallel to the light transmission axis of the first polarizer or the second polarizer. The second vertical alignment layer is formed on a pattern which is constituted by the first horizontal electrode 2041 and the second horizontal electrode 2042.

The operating principle of the liquid crystal display device in vertical alignment according to the present embodiment will be illustrated hereinafter with reference to FIGS. 2a to 5.

As shown in FIGS. 2a and 2b, the negative liquid crystal molecules are aligned perpendicular to a surface of the substrate when no power is supplied to the liquid crystal display device. That is, the liquid crystal display device is in a dark state.

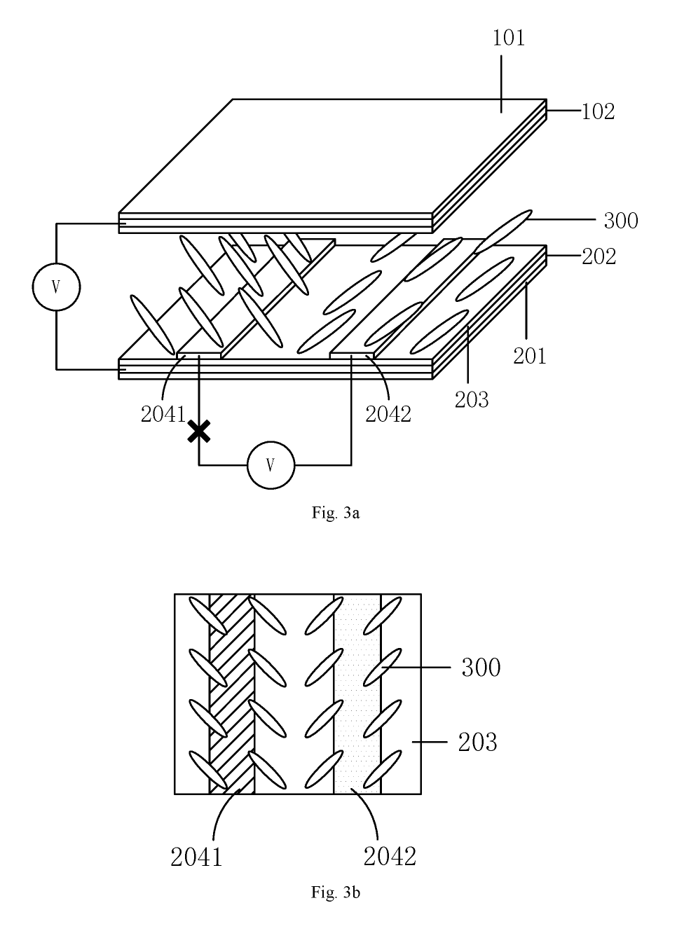

Further, as shown in FIGS. 3a and 3b, the liquid crystal display device is converted into a bright state as shown in FIG. 3a from the dark state as shown in FIG. 2a. Specifically, the first vertical electrode 102 and the second vertical electrode 202 are supplied with power, and a vertical electric field can be formed between the first vertical electrode 102 and the second vertical electrode 202. At this time, the negative liquid crystal molecules rotate by the action of the vertical electric field, and the liquid crystal display device is in a bright state. With respect to the liquid crystal display device comprising multiple quadrants, the negative liquid crystal molecules in different quadrants have different rotation directions.

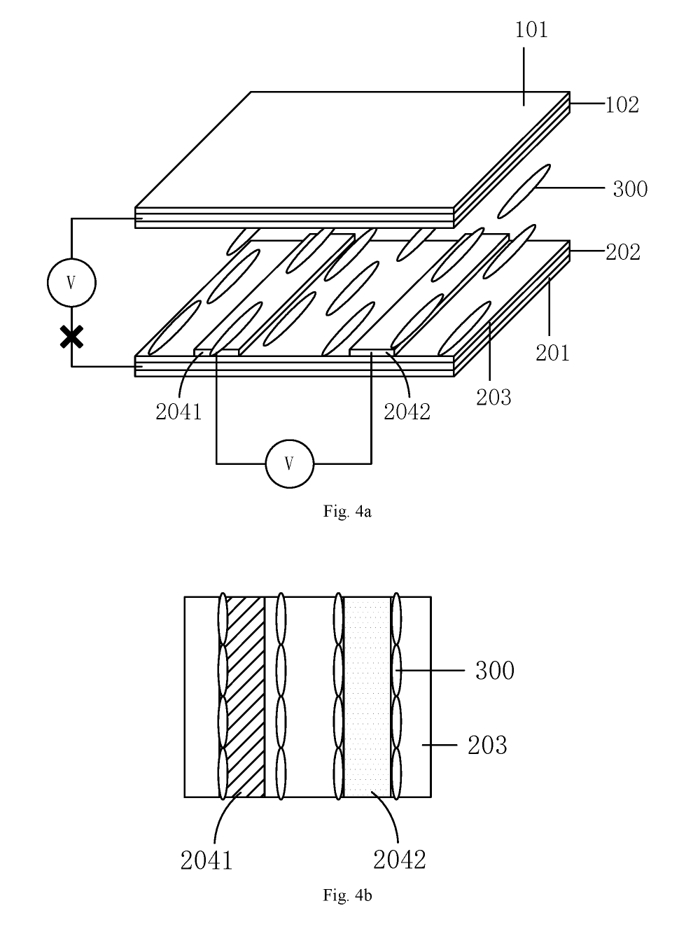

Then, as shown in FIGS. 4a and 4b, the liquid crystal display device is converted into a dark state as shown in FIG. 4a from the bright state as shown in FIG. 3a. The power supplied to the first vertical electrode 102 and the second vertical electrode 202 is stopped, and at the same time, the first horizontal electrode 2041 and the second horizontal electrode 2042 are supplied with power, so that a horizontal electric field is generated between the first horizontal electrode 2041 and the second horizontal electrode 2042. At this time, the negative liquid crystal molecules rotate to a direction perpendicular to the horizontal electric field by the action of the horizontal electric field, and the liquid crystal display device is in a dark state. Specifically, a time period during which power is supplied to the first horizontal electrode and the second horizontal electrode ranges from 1 ms to 10 ms. The first horizontal electrode 2041 and the second horizontal electrode 2042 are supplied with power, so that a voltage difference therebetween ranges from 2 V to 10 V, and a horizontal electric field can be generated.

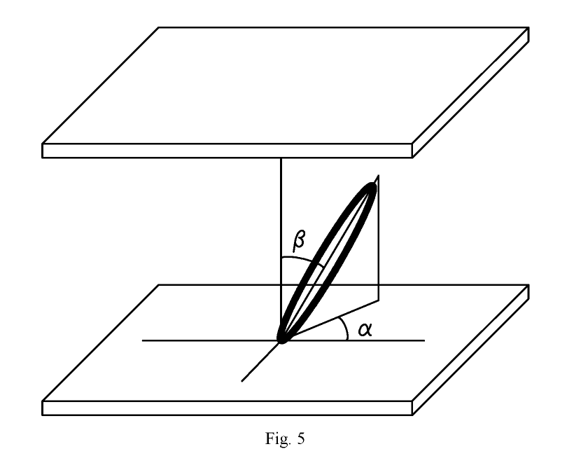

As shown in FIG. 5, according to the calculation formula of a light transmittance, i.e.,

$$T = \frac{1}{2} * {sin}^{2} ( 2 α ) * {sin}^{2} ( \frac{ϕ}{2} ) ,$$

it can be seen that, when β is 0°, there is no phase difference, i.e., φ is 0°. At this time, the liquid crystal display device is in a state as shown in FIGS. 2a and 2b. When β is not equal to 0° and α is 45°, the light transmittance T has a highest value. At this time, the liquid crystal display device is in a state as shown in FIGS. 3a and 3b. When α is 0° or 90°, the light transmittance T is zero. At this time, the liquid crystal display device is in a state as shown in FIGS. 4a and 4b. The process that the liquid crystal display device is converted into a dark state from a bright state is the process from FIG. 3a to FIG. 4a. It should be noted that, the liquid crystal display device is in a dark state in FIG. 4a and FIG. 2a. That is, when the liquid crystal display device is converted into a state as shown in FIG. 2a from a state as shown in FIG. 4a, the brightness thereof does not change.

It can be seen that, in the liquid crystal display device in vertical alignment according to the present embodiment, the first horizontal electrode and the second horizontal electrode are added on the basis of the traditional structure. A horizontal electric field can be formed between the first horizontal electrode and the second horizontal electrode, so that the negative liquid crystal molecules can rotate along horizontal direction to a direction of the light transmission axis of the polarizer. The process that the liquid crystal display device is converted into the dark state from the bright state can be accelerated, and the declining time can be effectively shortened. According to the present embodiment, the liquid crystal display device has a high response speed, and a better display effect can be obtained when a dynamic image which moves at a high speed is displayed.

According to the present embodiment, the rotation of the liquid crystal molecules can be accelerated by the horizontal electric field, while the structure of the liquid crystal cell and the liquid crystal material do not change. Therefore, the declining time can be shortened effectively, while other good performances of the liquid crystal display device would not be affected. The method disclosed herein has a good feasibility.

According to the aforesaid operating principle, the liquid crystal display device according to the present embodiment further comprises a driving circuit, which comprises a horizontal driving module and a vertical driving module.

Specifically, the horizontal driving module is configured to control conversion of the liquid crystal display device into a dark state from a bright state. The horizontal driving module is configured to stop supplying power to the first vertical electrode 102 and the second vertical electrode 202, at the same time, start to supply power to the first horizontal electrode 2041 and the second horizontal electrode 2042, and enable a voltage difference between the first horizontal electrode 2041 and the second horizontal electrode 2042 to reach a first preset voltage difference. The horizontal driving module is configured to stop supplying power to the first horizontal electrode 2041 and the second horizontal electrode 2042 when a time period during which power is supplied to the first horizontal electrode 2041 and the second horizontal electrode 2042 reaches a preset time period. Here, the first preset voltage difference preferably ranges from 2 V to 10 V. The preset time period preferably ranges from 1 ms to 10 ms.

The vertical driving module is configured to control conversion of the liquid crystal display device into a bright state from a dark state. The vertical driving module is specifically configured to supply power to the first vertical electrode 102 and the second vertical electrode 202, and enable a voltage difference between the first vertical electrode 102 and the second vertical electrode 202 to reach a second preset voltage difference.

Accordingly, the embodiment of the present disclosure further provides a method for driving the aforesaid liquid crystal display device in vertical alignment, and the method comprises controlling conversion of the liquid crystal display device into a dark state from a bright state.

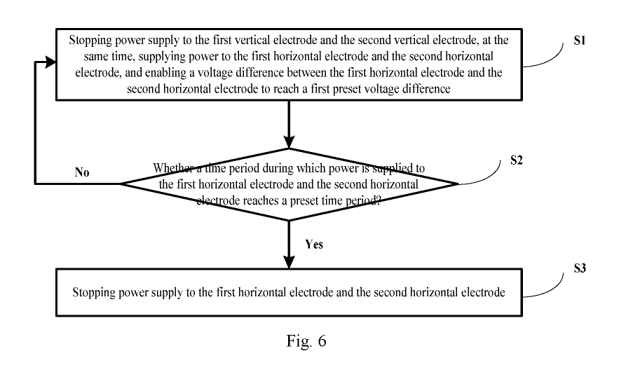

FIG. 6 is a flow chart of the method for controlling conversion of the liquid crystal display device into a dark state from a bright state according to the present embodiment. The method for controlling conversion of the liquid crystal display device into a dark state from a bright state mainly comprises step 1 to step 3.

In step 1, the power supplied to the first vertical electrode 102 and the second vertical electrode 202 is stopped, at the same time, the first horizontal electrode 2041 and the second horizontal electrode 2042 are supplied with power, and a voltage difference between the first horizontal electrode 2041 and the second horizontal electrode 2042 is enabled to reach a first preset voltage difference. Here, the first preset voltage difference preferably ranges from 2 V to 10 V.

In step 2, whether a time period during which power is supplied to the first horizontal electrode and the second horizontal electrode reaches a preset time period is determined. Here, the preset time period preferably ranges from 1 ms to 10 ms.

In step 3, if a determination result of step 2 is yes, the power supplied to the first horizontal electrode and the second horizontal electrode is stopped.

According to a preferred embodiment of the present disclosure, the aforesaid driving method further comprises controlling conversion of the liquid crystal display device into a bright state from a dark state, which comprises supplying power to the first vertical electrode 102 and the second vertical electrode 202, and enabling a voltage difference between the first vertical electrode 102 and the second vertical electrode 202 to reach a second preset voltage difference.

It can be seen that, in the method for driving the liquid crystal display device in vertical alignment according to the present embodiment, a horizontal electric field can be formed between the first horizontal electrode and the second horizontal electrode, so that the negative liquid crystal molecules can rotate along horizontal direction to a direction of the light transmission axis of the polarizer. The process in which the liquid crystal display device is converted into the dark state from the bright state can be accelerated, and the declining time can be effectively shortened. According to the present embodiment, the response speed of the liquid crystal display device can be improved, and a better display effect can be obtained when a dynamic image which moves at a high speed is displayed.

According to the present embodiment, the rotation of the liquid crystal molecules can be accelerated by the horizontal electric field, while the structure of the liquid crystal cell and the liquid crystal material do not change. Therefore, the declining time can be shortened effectively, while other good performances of the liquid crystal display device would not be affected. The method disclosed herein has a good feasibility.

The above embodiments are described only for better understanding, rather than restricting, the present disclosure. Any person skilled in the art can make amendments to the implementing forms or details without departing from the spirit and scope of the present disclosure. The protection scope of the present disclosure shall be determined by the scope as defined in the claims.

1. A liquid crystal display device in vertical alignment, comprising:
a first substrate and a second substrate that are arranged facing each other, and a negative liquid crystal layer that is arranged between the first substrate and the second substrate;
a first polarizer and a second polarizer that are formed on an outer surface of the first substrate and an outer surface of the second substrate respectively, a light transmission axis of the first polarizer being perpendicular to a light transmission axis of the second polarizer;
a first vertical electrode and a first vertical alignment layer that are formed on an inner surface of the first substrate in sequence; and
a second vertical electrode, an insulation layer, a first horizontal electrode, a second horizontal electrode, and a second vertical alignment layer that are formed on an inner surface of the second substrate in sequence, wherein the first horizontal electrode and the second horizontal electrode are arranged parallel to each other in a same layer and parallel to the light transmission axis of the first polarizer or the second polarizer.

2. The liquid crystal display device according to claim 1, further comprising a driving circuit, which comprises a horizontal driving module, wherein the horizontal driving module is configured to control conversion of the liquid crystal display device into a dark state from a bright state,
wherein the horizontal driving module is configured to stop supplying power to the first vertical electrode and the second vertical electrode, start to supply power to the first horizontal electrode and the second horizontal electrode at the same time, and enable a voltage difference between the first horizontal electrode and the second horizontal electrode to reach a first preset voltage difference; and
wherein the horizontal driving module is configured to stop supplying power to the first horizontal electrode and the second horizontal electrode when a time period during which power is supplied to the first horizontal electrode and the second horizontal electrode reaches a preset time period.

3. The liquid crystal display device according to claim 2, wherein the first preset voltage difference ranges from 2 V to 10 V, and/or the preset time period ranges from 1 ms to 10 ms.

4. The liquid crystal display device according to claim 2, wherein the driving circuit further comprises a vertical driving module, which is configured to control conversion of the liquid crystal display device into a bright state from a dark state, and
wherein the vertical driving module is specifically configured to supply power to the first vertical electrode and the second vertical electrode, and enable a voltage difference between the first vertical electrode and the second vertical electrode to reach a second preset voltage difference.

5. The liquid crystal display device according to claim 1, wherein the first vertical electrode and the second vertical electrode both are planar electrodes.

6. The liquid crystal display device according to claim 5, further comprising a driving circuit, which comprises a horizontal driving module, wherein the horizontal driving module is configured to control conversion of the liquid crystal display device into a dark state from a bright state,
wherein the horizontal driving module is configured to stop supplying power to the first vertical electrode and the second vertical electrode, start to supply power to the first horizontal electrode and the second horizontal electrode at the same time, and enable a voltage difference between the first horizontal electrode and the second horizontal electrode to reach a first preset voltage difference; and
wherein the horizontal driving module is configured to stop supplying power to the first horizontal electrode and the second horizontal electrode when a time period during which power is supplied to the first horizontal electrode and the second horizontal electrode reaches a preset time period.

7. The liquid crystal display device according to claim 6, wherein the first preset voltage difference ranges from 2 V to 10 V, and/or the preset time period ranges from 1 ms to 10 ms.

8. The liquid crystal display device according to claim 6, wherein the driving circuit further comprises a vertical driving module, which is configured to control conversion of the liquid crystal display device into a bright state from a dark state, and
wherein the vertical driving module is specifically configured to supply power to the first vertical electrode and the second vertical electrode, and enable a voltage difference between the first vertical electrode and the second vertical electrode to reach a second preset voltage difference.

9. The liquid crystal display device according to claim 5, wherein the first horizontal electrode and/or the second horizontal electrode is a comb electrode.

10. The liquid crystal display device according to claim 9, further comprising a driving circuit, which comprises a horizontal driving module, wherein the horizontal driving module is configured to control conversion of the liquid crystal display device into a dark state from a bright state,
wherein the horizontal driving module is configured to stop supplying power to the first vertical electrode and the second vertical electrode, start to supply power to the first horizontal electrode and the second horizontal electrode at the same time, and enable a voltage difference between the first horizontal electrode and the second horizontal electrode to reach a first preset voltage difference; and
wherein the horizontal driving module is configured to stop supplying power to the first horizontal electrode and the second horizontal electrode when a time period during which power is supplied to the first horizontal electrode and the second horizontal electrode reaches a preset time period.

11. The liquid crystal display device according to claim 10, wherein the first preset voltage difference ranges from 2 V to 10 V, and/or the preset time period ranges from 1 ms to 10 ms.

12. The liquid crystal display device according to claim 10, wherein the driving circuit further comprises a vertical driving module, which is configured to control conversion of the liquid crystal display device into a bright state from a dark state, and
wherein the vertical driving module is specifically configured to supply power to the first vertical electrode and the second vertical electrode, and enable a voltage difference between the first vertical electrode and the second vertical electrode to reach a second preset voltage difference.

13. The liquid crystal display device according to claim 9,
wherein the light transmission axis of the first polarizer extends along a 0° direction, and the light transmission axis of the second polarizer extends along a 90° direction; or
wherein the light transmission axis of the first polarizer extends along a 90° direction, and the light transmission axis of the second polarizer extends along a 0° direction.

14. The liquid crystal display device according to claim 13, further comprising a driving circuit, which comprises a horizontal driving module, wherein the horizontal driving module is configured to control conversion of the liquid crystal display device into a dark state from a bright state,
wherein the horizontal driving module is configured to stop supplying power to the first vertical electrode and the second vertical electrode, start to supply power to the first horizontal electrode and the second horizontal electrode at the same time, and enable a voltage difference between the first horizontal electrode and the second horizontal electrode to reach a first preset voltage difference; and
wherein the horizontal driving module is configured to stop supplying power to the first horizontal electrode and the second horizontal electrode when a time period during which power is supplied to the first horizontal electrode and the second horizontal electrode reaches a preset time period.

15. The liquid crystal display device according to claim 14, wherein the first preset voltage difference ranges from 2 V to 10 V, and/or the preset time period ranges from 1 ms to 10 ms.

16. The liquid crystal display device according to claim 14, wherein the driving circuit further comprises a vertical driving module, which is configured to control conversion of the liquid crystal display device into a bright state from a dark state, and
wherein the vertical driving module is specifically configured to supply power to the first vertical electrode and the second vertical electrode, and enable a voltage difference between the first vertical electrode and the second vertical electrode to reach a second preset voltage difference.

17. A method for driving the liquid crystal display device in vertical alignment according to claim 1, comprising controlling conversion of the liquid crystal display device into a dark state from a bright state, which comprises:
stopping power supply to the first vertical electrode and the second vertical electrode, at the same time, supplying power to the first horizontal electrode and the second horizontal electrode, and enabling a voltage difference between the first horizontal electrode and the second horizontal electrode to reach a first preset voltage difference;
determining whether a time period during which power is supplied to the first horizontal electrode and the second horizontal electrode reaches a preset time period; and
if yes, stopping power supply to the first horizontal electrode and the second horizontal electrode.

18. The method according to claim 17, further comprising controlling conversion of the liquid crystal display device into a bright state from a dark state, which comprises supplying power to the first vertical electrode and the second vertical electrode, and enabling a voltage difference between the first vertical electrode and the second vertical electrode to reach a second preset voltage difference.

19. The method according to claim 17, wherein the first preset voltage difference ranges from 2 V to 10 V, and/or the preset time period ranges from 1 ms to 10 ms.

20. The method according to claim 19, further comprising controlling conversion of the liquid crystal display device into a bright state from a dark state, which comprises supplying power to the first vertical electrode and the second vertical electrode, and enabling a voltage difference between the first vertical electrode and the second vertical electrode to reach a second preset voltage difference.
